(19) United States
(12) Patent Application Publication
(10) Pub. No.: US 2025/0251710 A1
(43) Pub. Date: Aug. 7, 2025

(54) MOTOR MONITORING DEVICE

(71) Applicant: FANUC CORPORATION, Yamanashi (JP)

(72) Inventors: Kenji SHIMIZU, Yamanashi (JP); Makoto HAGA, Yamanashi (JP)

(73) Assignee: FANUC CORPORATION, Yamanashi (JP)

(21) Appl. No.: 18/855,603

(22) PCT Filed: Jun. 14, 2022
(86) PCT No.: PCT/JP2022/023771

§ 371 Date: Oct. 9, 2024

(51) Int. Cl. G05B 19/4065

(52) U.S. Cl. CPC G05B 19/4065; G05B 2219/37081; G05B 2219/37084; G05B 2219/37245

(57) ABSTRACT

According to one embodiment of the present disclosure, a motor monitoring device that can easily ascertain the state of a motor comprises a rotational speed acquisition unit that acquires the rotational speed of a motor that operates in accordance with an operation program, an output value acquisition unit that acquires an output value for the motor, and a graph display unit that plots a marker that represents a combination of the rotational speed and the output value at a graph area where one axis is the rotational speed and the other axis is the output value. The graph display unit has a unit area setting unit that sets a plurality of unit areas that divide the graph area into a grid and a format modification unit that modifies the display format of the marker by unit area in accordance with a prescribed indicator.

### TECHNICAL FIELD

The present invention relates to a motor monitoring device.

### BACKGROUND ART

For example, in motors such as spindle motors used in machine tools, where the load can significantly vary, there is a risk of overheating if a high load state persists and heat accumulates. Various time ratings can be set for such motors to ensure operation without overheating under specific conditions. For example, the time ratings specified in JIS-C4034-1 include continuous ratings enabling continuous operation, short-time ratings enabling operation for a certain period (load time) in a case where the operation starts at room temperature, and repetitive ratings enabling operation for a certain period (load time ratio) within a specified cycle time.

It has been proposed to estimate the time until a motor overheats while maintaining the current operational state (see, for example, Patent Document 1). Knowing the time until overheating can help determine whether the current machining operation can be completed.

### CITATION LIST

### Patent Document

Patent Document 1: Japanese Patent No. 5628994

### DISCLOSURE OF THE INVENTION

### Problems to be Solved by the Invention

However, estimating only the time until overheating does not allow for easily understanding the motor's operational safety and margin. Specifically, when the settings such as motor speed is adjusted to maximize the efficient machining while minimizing the margin for overheating, it is not easy to determine how much the set values should be increased or decreased. Therefore, a technique that allows for easily understanding the motor's state is desired.

### Means for Solving the Problems

The motor monitoring device according to one aspect of the present disclosure includes: a rotation number acquisition unit that acquires a rotation number of a motor operating in accordance with an operational program; an output value acquisition unit that acquires an output value of the motor; and a graph display unit that plots a marker indicating a combination of the rotation number and the output value on a graph area, with one axis representing the rotation number and the other axis representing the output value, in which the graph display unit includes: a unit area setting unit that sets a plurality of unit areas by dividing the graph area into a grid pattern; and a mode changing unit that changes a display mode of the marker for each of the unit areas in accordance with a predetermined index.

### Effects of the Invention

According to the present disclosure, the motor's state can be easily understood.

### BRIEF DESCRIPTION OF THE DRAWINGS

FIG. 1 is a block diagram illustrating the configuration of a machine tool including a motor monitoring device according to the first embodiment of the present disclosure;

FIG. 2 is a table illustrating the information stored by the information storage unit of the motor monitoring device of FIG. 1; and

FIG. 3 is a diagram illustrating a screen displayed by the motor monitoring device of FIG. 1.

### PREFERRED MODE FOR CARRYING OUT THE INVENTION

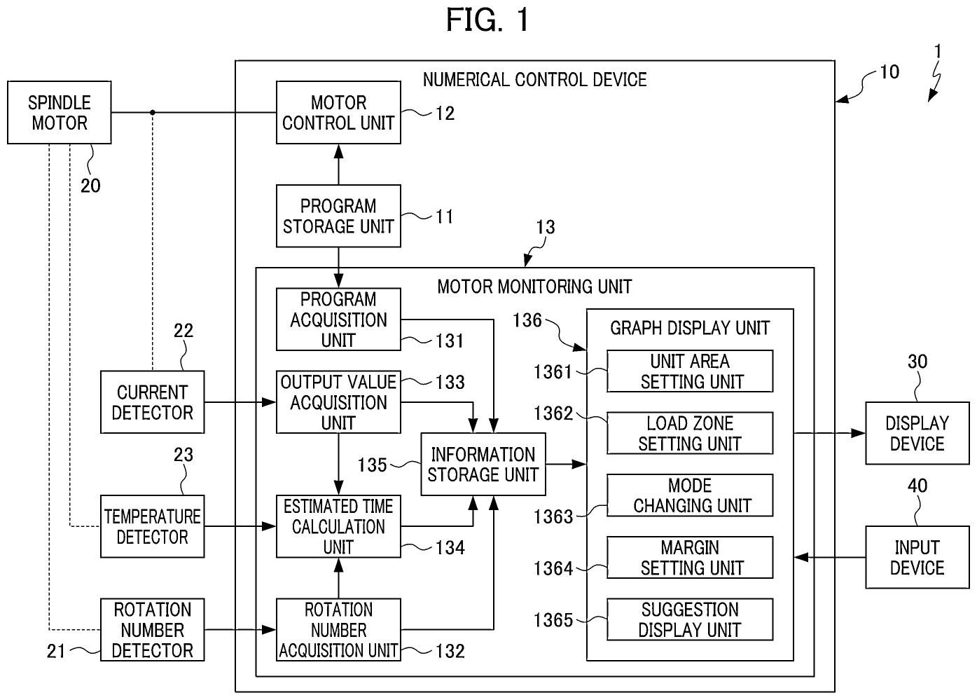

Hereinafter, embodiments of the present disclosure will be described with reference to the drawings. FIG. 1 is a block diagram illustrating the configuration of a machine tool 1 including a motor monitoring device according to the first embodiment of the present disclosure.

The machine tool 1 includes a numerical control device 10 as an embodiment of the motor monitoring device according to the present invention, a spindle motor 20, a rotation number detector 21 that detects the rotation number of the spindle motor 20, a current detector 22 that detects the current of the spindle motor 20, a temperature detector 23 that detects the winding temperature of the spindle motor 20, a display device 30 that displays a screen in accordance with the numerical control device 10, and an input device 40 used by the user to input into the numerical control device 10.

The numerical control device 10 controls the operation of the spindle motor 20 and other components in accordance with an operational program (referred to as a machining program in numerical control devices) to enable the machine tool 1 to perform predetermined machining on the workpiece. The numerical control device 10 includes a memory, a processor (CPU), input/output interfaces, etc., and can be implemented by one or more computer devices executing appropriate control programs. Components of the numerical control device 10 described below are categorized based on the functions of the numerical control device 10 and need not be distinctly separable in physical configuration and program configuration.

The spindle motor 20 is typically a motor that rotationally drives a cutting tool or workpiece. The spindle motor 20 operates in accordance with the operational program as described above, but the load can fluctuate independently of the rotation number, depending on the machining conditions. The rotation number detector 21, the current detector 22, and the temperature detector 23 can be composed of known sensors.

The display device 30 is a well-known display that displays in accordance with signals input from the numerical control device 10. The display device 30 may be integrated with the numerical control device 10. The input device 40 is a device used by the user to input information into the numerical control device 10 and may be composed of well-known components such as a keyboard or mouse. The input device 40 may also be integrated with the numerical control device 10. The input device 40 may also be integrated with the display device 30. Specifically, the display device 30 and the input device 40 may be a single input/output device such as a touch panel.

In the present embodiment, the numerical control device 10 includes: a program storage unit 11; a motor control unit 12 that controls the operation of motors that drive the drive axes of the machine tool 1 including the spindle motor 20; and a motor monitoring unit 13 that executes the functions of the motor monitoring device according to the present disclosure.

The program storage unit 11 stores operational programs executed by the machine tool 1. Each operational program includes a plurality of blocks that specify the unit operations of the machine tool 1. Each block includes one or more words formed by combinations of a plurality of characters (letters). Typically, each block is prefixed with a sequence number to identify the block.

The motor control unit 12 executes the machining procedures described in the operational program by controlling the spindle motor 20 and the motors of other drive axes of the machine tool 1 in accordance with the operational program. The configuration of the motor control unit 12 is the same as that of well-known numerical control devices, thus a detailed description is omitted.

The motor monitoring unit 13 includes a program acquisition unit 131, a rotation number acquisition unit 132, an output value acquisition unit 133, an estimated time calculation unit 134, an information storage unit 135, and a graph display unit 136.

The program acquisition unit 131 acquires an operational program from the program storage unit 11 that specifies the operation to be monitored for the spindle motor 20. In other words, the program acquisition unit 131 loads the target operational program into the working memory.

The rotation number acquisition unit 132 acquires the rotation number of the spindle motor 20 from the rotation number detector 21. The rotation number acquisition unit 132 may also acquire the rotation number of the spindle motor 20 via the motor control unit 12.

The output value acquisition unit 133 acquires the output values of the spindle motor 20, such as a current value, a power value, and a torque value. In the present embodiment, the output value acquisition unit 133 is configured to acquire the current value of the spindle motor 20 from the current detector 22 and to use the power value calculated from the current value as the output value. However, the output value acquisition unit 133 may be configured to use the detected value such as the current value directly as the output value. The output value acquisition unit 133 may also acquire the output value or the values necessary to calculate the output value from the motor control unit 12. The output value acquisition unit 133 may acquire two or more types of output values.

The estimated time calculation unit 134 calculates the estimated time to reach the overheating temperature in a case where the rotation number and the output value at that time are maintained by the spindle motor 20, based on the winding temperature of the spindle motor 20 acquired from the temperature detector 23 and the current value or output value acquired by the output value acquisition unit 133.

The information storage unit 135 stores history information on the operational state of the spindle motor 20 at regular time intervals. The operational state includes the rotation number and the output value, and may include position information indicating the position of the corresponding command in the operational program, and modal information specifying the operation of the spindle motor 20. The position information of the operational program includes sequence numbers, line numbers, block numbers, etc. The modal information includes commands extracted from the operational program (not limited to those directly specifying the operation of the spindle motor 20, but also including commands that may affect the operation of the spindle motor 20, such as a command specifying a tool), and setting values of the numerical control device 10, such as the upper limit of acceleration. The information storage unit 135 may pre-calculate values such as the load levels, which will be used later in the graph display unit 136, and store them as one of the elements of the operational information.

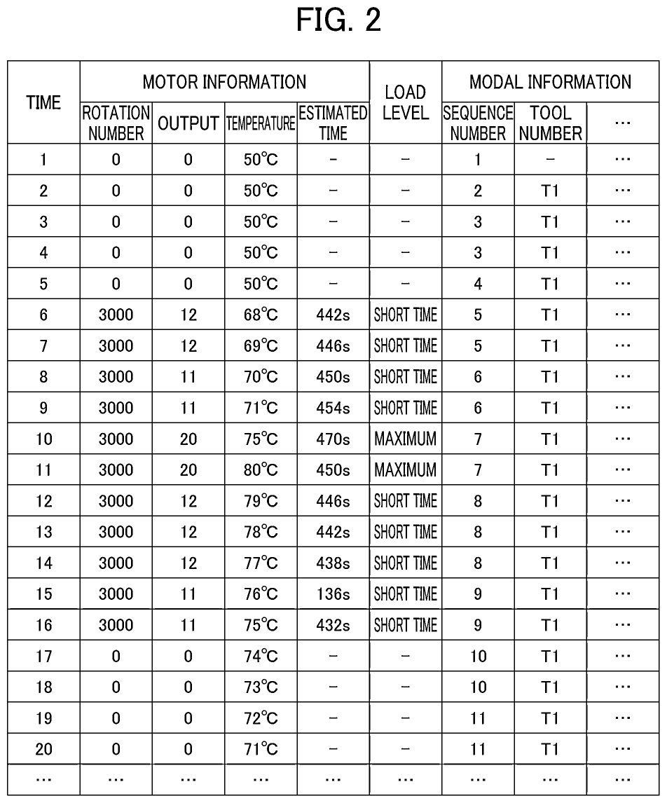

The time interval for storing operational information may be a predetermined fixed time or may be the time obtained by dividing the estimated machining time, derived from the operational program, by the preset number of times the operational information is to be acquired. The information storage unit 135 may be configured to store operational information at time intervals specified by the user via the input device 40 or the like. FIG. 2 illustrates an example of the details of the operational information stored by the information storage unit 135. As is apparent from the drawing, the information storage unit 135 can be configured to create a relational database using the acquisition time or serial number of the data as a unique key for the operational information. The “-” in the drawing indicates that the calculation is not possible or the corresponding information does not exist.

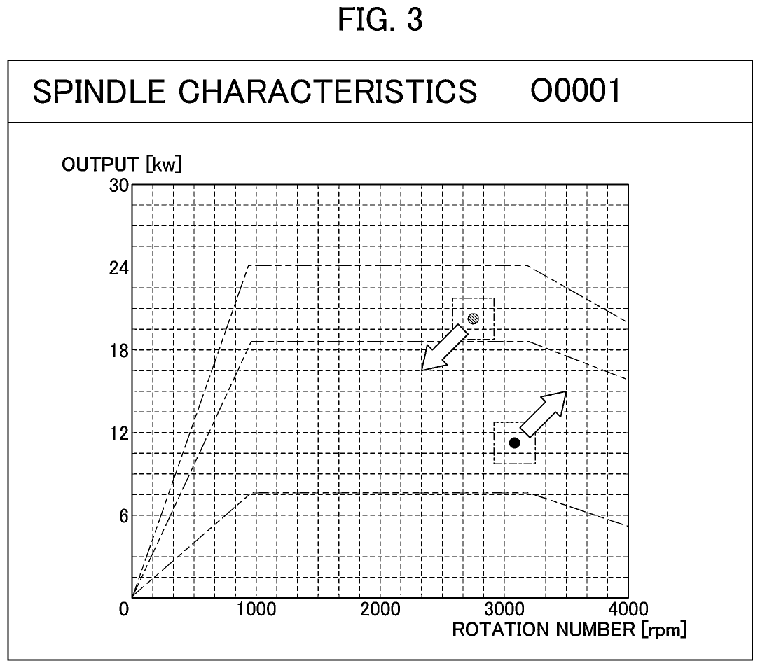

As illustrated in FIG. 3, the graph display unit 136 displays a graph in the graph area, plotting markers indicating the combinations of rotation number and output value, with one axis representing the rotation number and the other axis representing the output value. The graph display unit 136 includes a unit area setting unit 1361, a load zone setting unit 1362, a mode changing unit 1363, a margin setting unit 1364, and a suggestion display unit 1365.

The unit area setting unit 1361 sets a plurality of unit areas by dividing the graph area into a grid pattern. In FIG. 3, the boundaries of the unit areas are indicated by dashed lines. The boundaries of the unit areas are for the purpose of explaining the unit areas, and may not be present on the screen displayed by the display device 30. The unit area setting unit 1361 may determine the size of the unit areas, based on a user input. This ensures that the mode changing unit 1363 can secure the necessary amount of information to change the display mode of the markers while setting a sufficient number of unit areas. The unit area setting unit 1361 may be configured to allow the user to specify the length of the unit areas on each axis or the number of unit areas (divisions) on each axis.

The load zone setting unit 1362 divides the graph area into a plurality of load zones with different load levels. The load zones are set based on the combinations of rotation number and output value where the load on the spindle motor 20 is considered to be equal, such as setting based on the boundaries of various ratings. In FIG. 3, the graph area is divided into four zones: a continuous load zone allowing for continuous operation, a short-time load zone allowing for intermittent operation, a maximum load zone allowing for exceptional temporary operation, and a non-operational zone where operation is not allowed even for a short time, based on the continuous rating, short-the time rating, and the maximum output, indicated by the phantom lines. These boundary lines of the load zones may not be present on the screen displayed by the display device 30.

The mode changing unit 1363 changes the display mode of the markers for each unit in accordance with the predetermined index. This allows for displaying additional information on a two-dimensional graph, making it easier for the user to understand the state of the spindle motor 20. Changes to the mode of the markers by the mode changing unit 1363 can include, for example, changing colors in accordance with the value of the index (e.g., blue, yellow, red), changing the density or brightness in accordance with the value of the index, and changing the length or size of the markers in accordance with the value of the index. In other words, the mode changing unit 1363 preferably changes the display mode of the markers, based on a predetermined rule to make the magnitude of the index values identifiable.

The indices for determining the mode of the markers can include the frequency of occurrence of the combinations of rotation number and output value in each unit area, such as the load level determined by the load zone setting unit 1362, the estimated time to reach the overheating temperature calculated by the estimated time calculation unit 134, etc. The mode changing unit 1363 may change a plurality of display modes of the markers in accordance with a plurality of indices.

When changing the mode of the markers in accordance with the frequency of occurrence of the combinations of rotation number and output value in each unit area, the mode changing unit 1363 may change the display mode of the markers in accordance with the ratio of the number of operational information items belonging to the unit area to the total number of operational information items within a predetermined time range or the number of operational information items with a non-zero output value (excluding those with zero output value). In this manner, relative values are used instead of absolute numbers for frequency, the changes in the mode of the markers can be made more noticeable, making it easier for the user to understand the state of the spindle motor 20. The time range for counting the frequency of occurrence may be set with reference to the completion time of acceleration or deceleration of the spindle motor 20, or may be the entire range from the start to the end of the operation of the spindle motor 20.

The margin setting unit 1364 sets the margin amount, which is the allowable range of the distance from the boundary of the load zones for the combination of rotation number and output value. In FIG. 3, the boundary of the allowable range is indicated by the dash-dotted line. In the illustrated example, the boundary lines are rectangular since the allowable range is set for each axis, but the allowable range may be set as a two-dimensional distance considering both axes so that the boundary is circular. The boundary lines of the allowable range may not be present on the screen displayed by the display device 30.

The suggestion display unit 1365 adds a suggestion display to the markers to propose changes in the operational conditions of the spindle motor 20, based on the load level. In FIG. 3, a left-downward arrow suggesting a reduction in load is added as a suggestion display to the marker with a load level exceeding the time rating, and a right-upward arrow suggesting an increase in load is added as a suggestion display to the marker with a load level below the time rating. The output value of the spindle motor 20 is not set by itself but mainly increases with the rise in the rotation number of the spindle motor 20. As a result, the combination of rotation number and output value moves in the direction of the suggestion display arrow. The suggestion display unit 1365 may display the suggestion displays so as to be selectable by the user, and may launch an editor that allows for editing the corresponding portion of the operational program when a suggestion display is selected.

The suggestion display unit 1365 may be configured to add a suggestion display when the distance from the boundary of the load zone for the combination of rotation number and output value is equal to or greater than the margin amount. If the combination of rotation number and output value is close to the boundary of the load zone, suggesting an increase in output may cause the new combination of rotation number and output value to exceed the boundary of the load zone. Therefore, a change in the operational conditions of the spindle motor 20 is preferably suggested only when there is a sufficient distance to the boundary of the load zone. When suggesting a decrease in output, consideration of the margin amount is unnecessary from a safety perspective, but there is a potential disadvantage of increased machining time due to reduced output. Thus, when the distance is close to the boundary of the load zone, it may be preferable not to actively suggest a decrease in output.

The numerical control device 10 according to the present embodiment includes the graph display unit 136, which includes the unit area setting unit 1361 that sets a plurality of unit areas by dividing the graph area into a grid pattern, and the mode changing unit 1363 that changes the display mode of the markers for each unit area in accordance with the predetermined index, thereby allowing the user to understand the state of the spindle motor 20 from a plurality of perspectives.

Although the embodiments of the present disclosure have been described above, the present invention is not limited to the embodiments described above. The effects described in the above embodiments are merely examples of the preferred effects resulting from the present invention, and the effects of the present invention are not limited to those described in the above embodiments.

The motor monitoring device according to the present disclosure may be provided independently of the numerical control device that controls the machine tool, and may be used for monitoring the motors other than the spindle motor of the machine tool, such as the motor of a kneading machine. For example, the motor monitoring device according to the present disclosure may add the functions of the motor monitoring unit described in the above embodiments to a management computer that manages one or more numerical control devices, such as a control device for a kneading machine or a management computer that manages such a control device. In the motor monitoring device according to the present disclosure, the load zone setting unit, the margin setting unit, and the suggestion display unit are optional configurations.

### EXPLANATION OF REFERENCE NUMERALS

1: machine tool
10: numerical control device (motor monitoring device)
11: program storage unit
12: motor control unit
13: motor monitoring unit
131: program acquisition unit
132: rotation number acquisition unit
133: output value acquisition unit
134: estimated time calculation unit
135: information storage unit
136: graph display unit
1361: unit area setting unit
1362: load zone setting unit
1363: mode changing unit
1364: margin setting unit
1365: suggestion display unit
20: spindle motor
21: rotation number detector
22: current detector
23: temperature detector
30: display device
40: input device

1. A motor monitoring device, comprising:
a rotation number acquisition unit that acquires a rotation number of a motor operating in accordance with an operational program;
an output value acquisition unit that acquires an output value of the motor; and
a graph display unit that plots a marker indicating a combination of the rotation number and the output value on a graph area, with one axis representing the rotation number and the other axis representing the output value, wherein
the graph display unit includes:
a unit area setting unit that sets a plurality of unit areas by dividing the graph area into a grid pattern; and
a mode changing unit that changes a display mode of the marker for each of the unit areas in accordance with a predetermined index.

2. The motor monitoring device according to claim 1, further comprising:
an information storage unit that stores the rotation number and the output value at a regular time interval, wherein
the mode changing unit changes the display mode of the marker in accordance with a frequency of occurrence of the combination of the rotation number and the output value in each of the unit areas.

3. The motor monitoring device according to claim 2, wherein the mode changing unit changes the display mode of the marker in accordance with a frequency of occurrence of the combination of the rotation number and the output value within a predetermined time range with reference to a completion time of acceleration or deceleration of the motor.

4. The motor monitoring device according to claim 2, wherein the mode changing unit changes the display mode of the marker in accordance with a frequency of occurrence of the combination of the rotation number and the output value within an entire range from start to end of an operation of the motor.

5. The motor monitoring device according to claim 1, wherein the mode changing unit changes the display mode of the marker so as to allow a load level of the unit areas to be identified.

6. The motor monitoring device according to claim 1, wherein the unit area setting unit determines a size of the unit areas, based on a user input.

7. The motor monitoring device according to claim 1, wherein the graph display unit further includes:
a load zone setting unit that divides the graph area into a plurality of load zones with different load levels; and
a suggestion display unit that adds a suggestion display to the marker to propose a change in an operational condition of the motor, based on the load levels.

8. The motor monitoring device according to claim 7, wherein the graph display unit further includes:
a margin setting unit that sets a margin amount, which is an allowable range of a distance from a boundary of the load zone to the combination of the rotation number and the output value, and
the suggestion display unit adds the suggestion display in a case where a distance from the boundary of the load zone to the combination of the rotation number and the output value is equal to or greater than the margin amount.

9. The motor monitoring device according to claim 7, further comprising:
an estimated time calculation unit that calculates an estimated time to reach an overheating temperature in a case where the rotation number and the output value at that point in time are maintained by the motor, wherein
the mode changing unit changes the display mode of the marker in accordance with the estimated time.
